(19) United States
(12) Patent Application Publication
(10) Pub. No.: US 2003/0058077 A1
(43) Pub. Date: Mar. 27, 2003

(54) Ignition coil and method of making

(76) Inventors: Colin Hamer, Carmel, IN (US); John D. Truong, Mooresville, IN (US); Albert Anthony Skinner, Anderson, IN (US); Viorel N. Moga, Anderson, IN (US)

Correspondence Address: DELPHI TECHNOLOGIES, INC., Legal Staff, Mail Code: 480-414-420, P.O. Box 5052, Troy, MI, 48007-5052, US

(21) Appl. No.: 09/960,857

(22) Filed: Sep. 21, 2001

(51) Int. Cl. H01F 27/30

(52) U.S. Cl. 336/198

(57) ABSTRACT

An ignition coil is provided for an internal combustion engine. The ignition coil comprises a primary winding and a secondary winding. The primary winding is adapted to be electrically connected to a low-voltage ignition signal. The secondary winding is inductively coupled to the primary winding with more turns than the primary winding so that the secondary winding develops a high-voltage ignition signal in response to switching of the low-voltage ignition signal. The turns of the secondary winding are provided in successive layers. An uncured material is applied to the secondary winding prior to the placement of the successive layers. By using an uncured stage material, the coil can be made without the need for complex, expensive, time-consuming, and potentially unreliable impregnation techniques. The ignition coil can be used as a pencil coil for spark plugs of an internal combustion engine. Also provided is a method of manufacturing an ignition coil.

### TECHNICAL FIELD

The present application relates to an ignition coil and method of manufacturing.

### BACKGROUND

In recent years, efforts in the automotive industry have been directed to developing ignition coils that are located at each of the spark plugs of an internal combustion engine. Each spark plug therefore has its own ignition coil. A direct connection to the spark plug is preferred because it eliminates the need for high voltage wires from a distributor to each of the spark plugs. Instead, all of the wiring to the spark plugs from the power train control unit (PTCU) of the engine can be provided using inexpensive and compact low-voltage wiring.

Past efforts to provide a direct connection, however, have been complicated because of the limited amount of space at the top of a spark plug in modern engines. The spark plug typically is received in a rather narrow bore hole. Each ignition coil therefore must either fit within the narrow bore hole, or project out therefrom. The option of having the ignition coil project out from the bore hole is typically impractical because it prevents the space above the bore hole from being occupied by other engine components or the vehicle's hood.

As a result, the efforts to provide an ignition coil at each spark plug has resulted in the development of “pencil coils”. Pencil coils have an outer diameter that is small enough for the pencil coil to fit within the typical spark plug's bore hole. Even when insertion into a bore hole is not necessary, a reduction in size is desirable because it saves space under the vehicle's hood.

The ability to provide a sufficiently compact ignition coil, however, is limited by the ability to provide the requisite number of coil windings within the desired diameter. Compact ignition coils, such as pencil coils, typically develop relatively large voltage gradients across their secondary windings. The high voltage gradients, when combined with the compactness of the pencil coil, requires a strong, yet thin, dielectric barrier between the individual layers of the secondary winding.

Sufficiently strong dielectric barriers, heretofore, have been difficult and expensive to provide. They generally have required full impregnation between the individual layers of the secondary windings. Full impregnation, however, requires processing at a vacuum of about 1/1000 of an atmosphere (1 millibar). Without the requisite amount of vacuum, the reliability of achieving full impregnation diminishes. Some of the impregnation therefore will be partial, resulting in partial discharge corona and failure of the coil.

While equipment capable of achieving a vacuum of the requisite magnitude is available, it tends to be capital intensive. It typically requires an initial investment of at least one million dollars. A need therefore exists for an ignition coil that does not require full impregnation of each winding layer and which therefore is not so complicated or capital intensive to manufacture. This need extends to pencil coils, and other compact coil structures, where the desired overall dimensions of the coil restrict the amount of space available for the secondary windings.

### SUMMARY

An ignition coil for an internal combustion engine. The ignition coil comprises a primary winding and a secondary winding. The primary winding is adapted to be electrically connected to a low-voltage ignition signal. The secondary winding is inductively coupled to the primary winding with more turns than the primary winding so that the secondary winding develops a high-voltage ignition signal in response to switching of the low-voltage ignition signal. The turns of the secondary winding are provided in successive layers. A layer of tape is located between each of the successive layers. The tape has an adhesive material on both sides. The entire assembly is heat shrunk to further encapsulate the windings into the adhesive of the tape.

A method of manufacturing an ignition coil. The method comprises wrapping a first layer of a secondary winding material about an axis of a spool having an uncured stage material, repeating the steps of wrapping to define successive layers of a secondary winding, and applying a primary winding around the secondary winding.

A method of manufacturing a secondary winding of an ignition coil, comprising applying a first layer of tape a winding surface of a spool, the tape has an adhesive on both sides. Wrapping a first layer of secondary winding material about the first layer of tape to form a first layer. Wrapping a plurality of successive layers about the first layer, each of said successive layers having two layers of tape having adhesive on both sides and a layer of winding material disposed between said two layers of tape. Heating the secondary winding in order to further encapsulate the winding material into the adhesive.

Still other objects, advantages, and features of the present invention will become more readily apparent when reference is made to the accompanying drawings and the associated description contained herein.

### BRIEF DESCRIPTION OF THE DRAWINGS

FIG. 1 is cross-sectional view of an ignition coil;

FIG. 2 is cross-sectional view of a secondary spool for use in an ignition coil;

FIG. 3 is an enlarged cross-sectional view of a portion of a secondary winding of the ignition coil;

FIG. 4 is an enlarged cross-sectional view of a portion of a secondary winding of the ignition coil illustrating the winding of the secondary wire;

FIG. 5 is a cross-sectional view of a secondary winding of the ignition coil;

FIG. 6 is an enlarged cross-sectional view of a portion of the secondary winding of the ignition coil;

FIG. 7 is a cross-sectional view of an alternative embodiment of the present invention;

FIG. 8 is a cross-sectional view of a secondary winding of an ignition coil constructed in accordance with the present invention;

FIG. 9 is a cross-sectional view of an alternative embodiment of the present invention;

FIG. 10 is an enlarged cross-sectional view of a portion of a secondary winding of the ignition coil;

FIG. 11 is an enlarged cross-sectional view of a portion of the secondary winding of the ignition coil;

FIG. 12 is a cross-sectional view of an alternative embodiment of the present invention; and

FIG. 13 is cross-sectional view of an ignition coil.

### DESCRIPTION OF THE PREFERRED EMBODIMENT

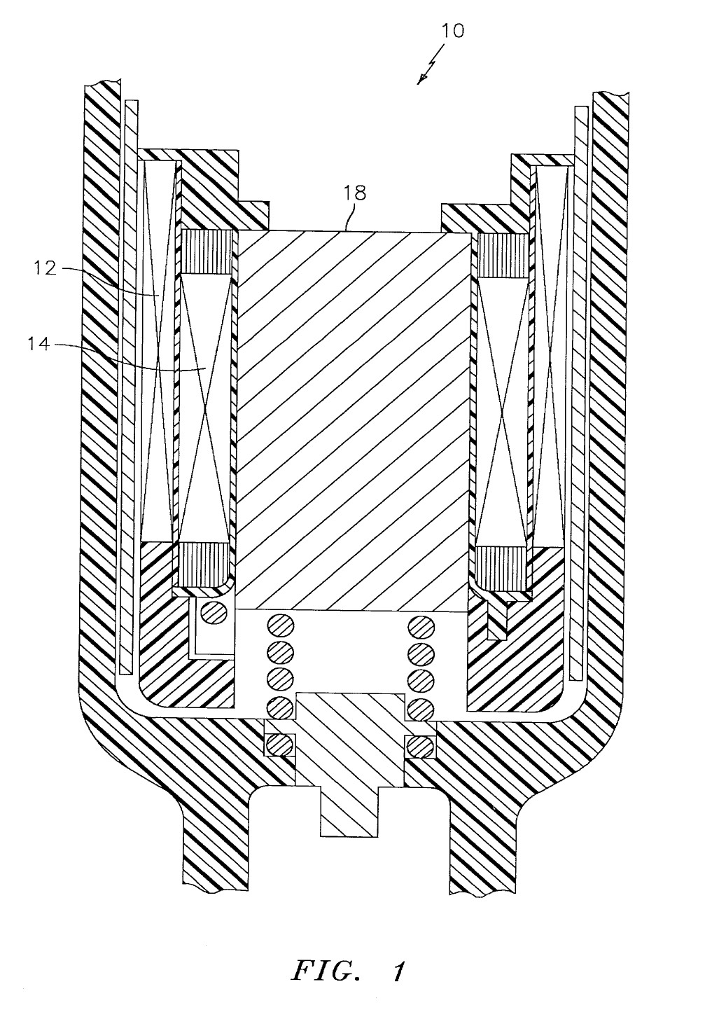

With reference to FIG. 1, an ignition coil 10 includes a primary winding 12 and a secondary winding 14. Both of the windings 12 and 14 circumferentially surround the same magnetic core 18. The magnetic core 18 preferably is made of iron.

The ignition coil 10 can be installed in an automotive vehicle or otherwise to provide sparks in one or more combustion chambers of an internal combustion engine via spark plugs located therein. The automotive implementation of the present invention represents a preferred use upon which the following description will be based. The invention, however, is not limited to such use. To the contrary, the present invention can be used in connection with other implementations of an internal combustion engine.

The primary winding 12 is adapted to be electrically connected to a low-voltage ignition signal. Terminals (not shown), for example, can be electrically connected to respective ends of the primary winding 12. These terminals then can be connected to the low-voltage ignition signal through soldering or any other suitable connection technique.

The secondary winding 14 is inductively coupled to the primary winding 12 with more turns than the primary winding 12 so that any voltage induced across the secondary winding 14 in response to switching of the low-voltage ignition signal causes the secondary winding 14 to develop a high-voltage ignition signal.

Current pencil coil designs use Epoxy to remove the air from within windings and to provide overall dielectric strength. Epoxy however has a number of disadvantages. First, the equipment for the controlled dispensing, which needs to be carried out with vacuum, is very expensive. Second, the Epoxy is also very sensitive to thermal conditions.

In a pencil coil with a correct controlled “Progressive” winding the Epoxy (encapsulant) is of greatest importance at the inside diameter of the winding.

To enable this surface to be “wetted” with the Epoxy, first the Epoxy has to penetrate the entire thickness of wire. If this interface could be taken care of in another manner it would be possible to remove the rest of the Epoxy.

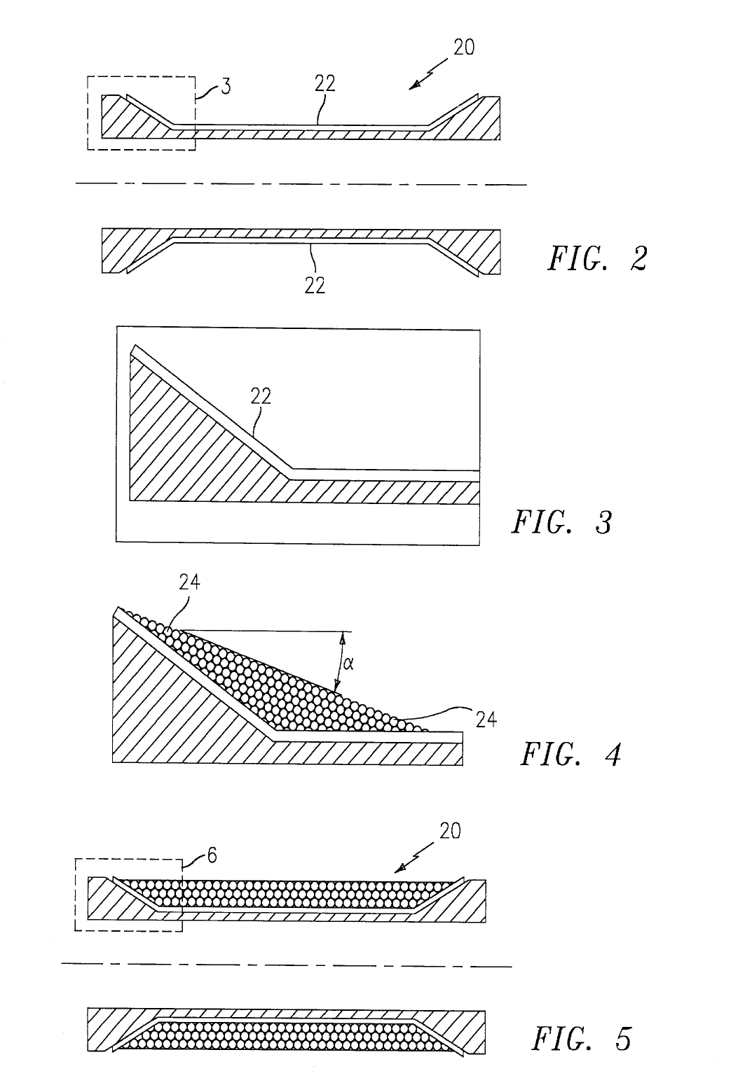

In accordance with an exemplary embodiment of the present invention, and referring now to FIG. 2, a secondary spool 20 is applied with an uncured stage material 22. In accordance with this embodiment uncured stage material 22 is an epoxy, silicone, etc. or equivalent thereof. The uncured stage material 22 is applied along the entire surface to be wound. Material 22 is applied with a thickness sufficient to cover more than the diameter of a secondary wire 24. For example, and in accordance with an exemplary embodiment the diameter of secondary wire 24 is 0.06 mm. The diameter of secondary wire is provided as an example of a preferred dimension, however, the scope of the present invention is not intended to be limited by the same.

The secondary wire 24 is wound onto the spool and the wire presses into the material 22. The winding needs to processed in such a way that the air cannot be ionized under normal operating conditions. This is accomplished by winding the secondary winding at a winding angle α as illustrated in FIG. 4. In accordance with an exemplary embodiment, the degree of angle α is approximately 5-20 degrees. Of course, and as applications may require, (such as the configuration of secondary spool) the degree of angle α may vary.

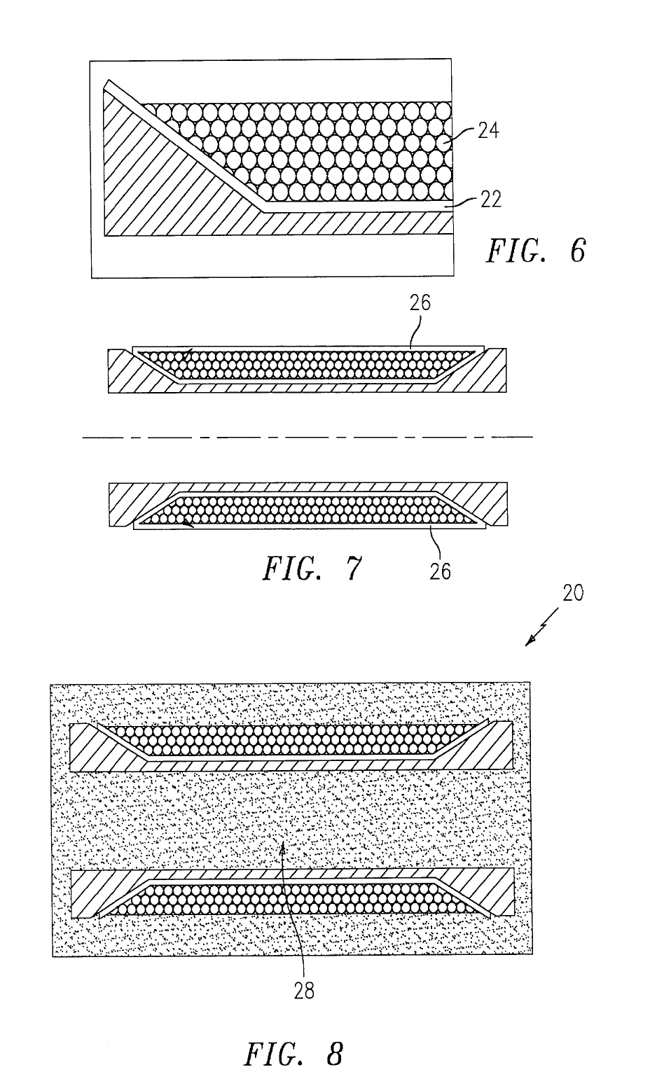

Once the portion of the secondary windings is completed as illustrated in FIG. 4, the secondary winding is then completed as illustrated in FIGS. 5 and 6.

As an alternative, and as illustrated in FIG. 7, the completed secondary winding 14 can then be applied with an optional lacquer coating 26 either for strength or as a release mechanism. The release mechanism provides a non-stick surface which will reduce frictional loading. For example, it is not always beneficial to adhere two surfaces when encountering a thermomechanical event, a method to manage stress it to insure that there is no adhesion. In this example, the lacquer could act as a dielectric barrier that would not stick to any other encapsulant.

After the rest of the assembly has been completed the entire part can then be encapsulated with a low modulus material 28 as illustrated in FIG. 7. This material can be dispensed with simple equipment without the use of vacuum. An example of a low modulus material silicone gel, poly-butadiene and equivalent thereof.

The resultant product is one with protection where it is needed without the use of an expensive epoxy resin.

As discussed above, a driver of both cost and quality of ignition coils is the requirement to pot the parts with epoxy, under vacuum. In layer wound coils (e.g. layers insulated by paper) the paper must get fully impregnated by the epoxy. This restricts the materials and processes that can be used to impregnate/encapsulate the coil.

Other windings such as a segmented winding or a progressive winding, the wire bundle must still be fully impregnated. Layer winding has a benefit of a more repeatable placement of the wire, with insulation between each layer. However, in paper layer windings, other than impregnation, there is a possibility of dropped turns, and telescoping layers. In order to avoid these conditions and provide a low cost layered secondary that does not require impregnation, an alternative embodiment is disclosed.

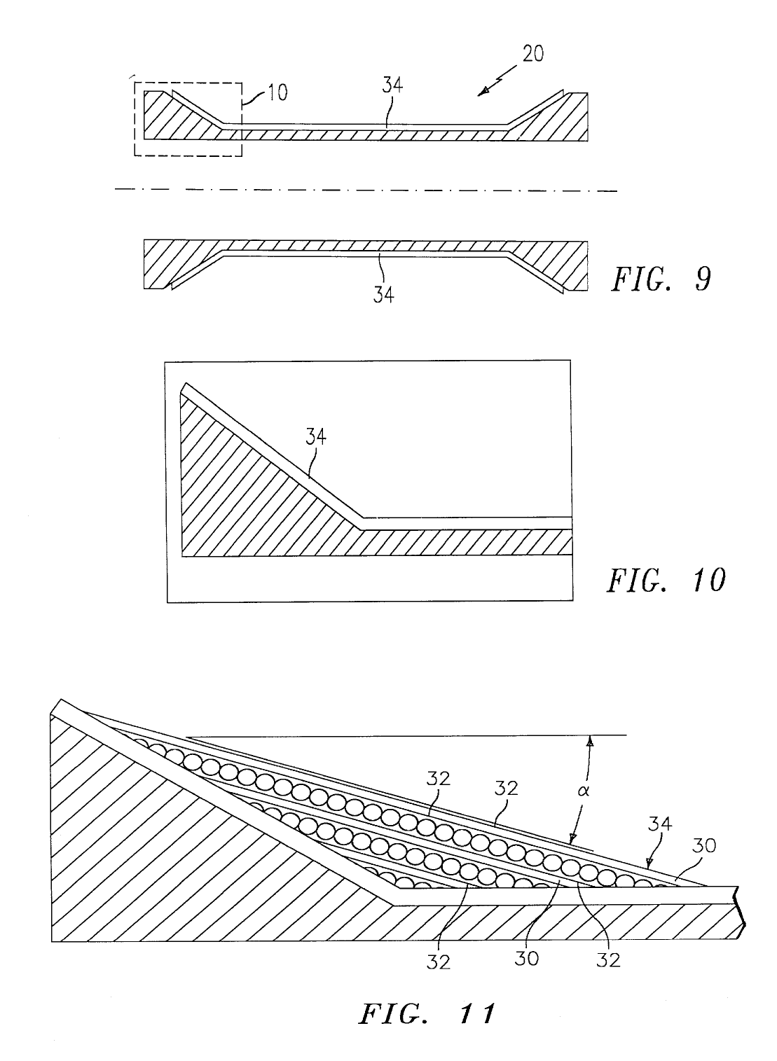

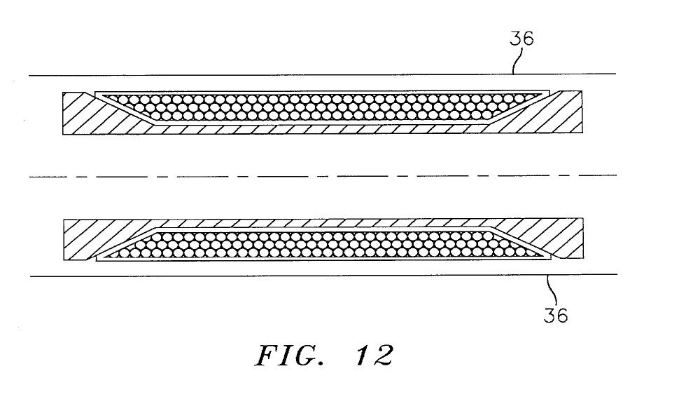

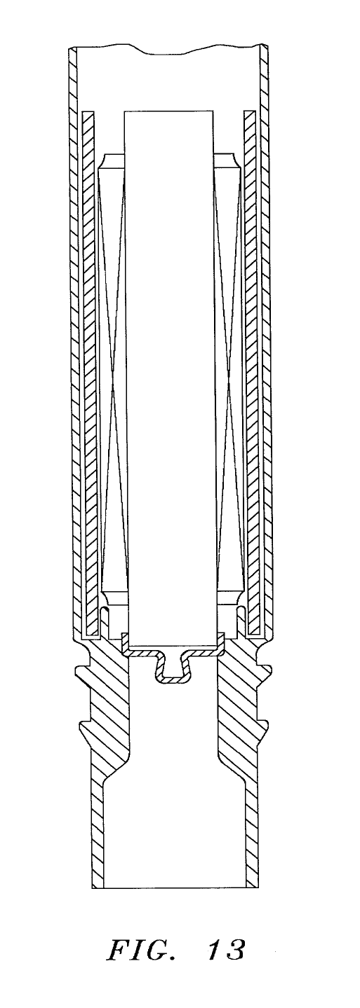

Referring now to FIGS. 9-12, the uncured stage material is replaced by a heat shrinkable material 30, such as polyester. Many films are available that at 0.001 inches to 0.002 inches thickness which can withstand the 1500 to 3000 volts that will be sent between the layers. This film, or substrate, will be coated with 0.0005 inches to 0.002 inches of adhesive 32 on both sides. Adhesives could include commonly used materials such as acrylic or silicone. As used herein, this material will be referred to as tape 34. An initial layer of tape 34 is placed onto a spool, a tube, or preferably directly over the core, to start the winding.

The first layer would have to be electrically terminated to the core. There are many ways this could be accomplished. An example would be to place a pre-soldered flat terminal onto the tape, wind a few wraps of wire around the tape, over the terminal, and reflow the solder. After the wire is terminated the winding of the first layer can begin. This could be on the same first layer of tape, or another layer of tape could be placed over the termination and then the first layer begins.

As each layer winds, the tension from the winder will imbed the wire into the glue, helping to keep the wire from slipping during the winding process. When the next layer of tape is placed over a finished winding layer, the portion of the wire that is still above the adhesive of the previous layer of tape may penetrate into the adhesive of the new, or top, layer of tape. This continues until 10 to 30 layers, depending on the design, are built up. Then a final layer of tape is applied and a termination is made. This could again be a termination similar to the one made at the start. After the winding is complete the secondary would be heated to 180 degrees Celsius to shrink the substrate of the tape. This forces the adhesive to encapsulate the wire and push out air. This process also seals up the ends of the layers. There would be 3 to 10 mm of tape extending beyond the end of the layer winding on each end. If required a vacuum may be pulled on the assembly prior to and during the shrink process to aid in the elimination of the air. Alternative tape structures include the tape described above is replaced with a 0.001 inches to 0.002 inches of shrinkable film that has a tape pre-applied to each side. This tape would be 0.0005 inches to 0.002 inches thick with 0.0005 inches to 0.002 inches of adhesive per side and would not be shrinkable.

In this embodiment, the tape can be placed as illustrated in FIG. 11 or alternatively the spool can be wound with the tape layer being inserted in between each successive layer of winding thus and in this embodiment, there is no requirement for the secondary to be wound at an angle as illustrated in FIG. 11.

Another option or alternative is the use of non-shrinkable two sided tape in the layers and then the entire winding is covered with a shrinkable tube 36 over the entire assembly. An exemplary material for tube 36 is poly-esterene (ASK MARK ABOUT SPELLING) tube or film. The adhesive eliminates any dropped turns or telescoping layers. For a pencil type coil the core would be at high voltage with the option of welding the terminal from the first layer to the core and letting the core carry the current to the terminal in the coil case. The primary would be wound external to the secondary, either on a spool, a formed tube, or preferably a self-bonded free-standing winding. With the primary over the secondary it could be placed in a case and then encapsulated with many different encapsulants. The encapsulant may be put into the case prior to assembling the core/secondary/primary into the case.

In accordance with the present invention a coil is capable of being manufactured at a lower cost and lower investment. The investment reduction will be less than the 1.2 million for a vacuum potting system. Without the need for a vacuum potting system low volume assembly cells would be more commercially viable. In addition, there is also a lot of labor and maintenance associated with the potters and accordingly, the need for this will be reduced.

The invention, of course, is not limited to the exemplary dimensions. To the contrary, as restrictions on available space and the coil requirements change, corresponding adjustments can be made to the various coil parameters (e.g., dimensions, numbers of windings, gauge of wire, and the like). Notably, the present invention allows the thickness of the secondary winding 14 to be reduced, without incurring the reliability problems that arise in conventional full impregnation techniques, and also without the expense of generating the typical magnitude of vacuum necessary to provide a reasonably reliable impregnation at such small diameters. As a result, the present invention generally permits the use of an in-bore coil over a wider range of coil requirements than conventional impregnation based arrangements. A significant savings in overall cost is likewise achieved.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A secondary winding for use in an ignition coil, comprising:
a spool having a winding surface;
an uncured stage material being applied to said winding surface;
a first winding layer being wound onto said winding surface, said first winding layer being encapsulated in said uncured stage material; and
a plurality of layers being wound on top of said first winding layer.

2. The secondary winding as in claim 1, further comprising:
a coating layer being applied to an outer most layer of said plurality of layers.

3. The secondary winding as in claim 2, wherein the coating layer is a lacquer

4. The secondary winding as in claim 1, wherein said uncured stage material is a silicon gel.

5. The secondary winding as in claim 1, further comprising:
an encapsulating layer being applied to said secondary winding.

6. The secondary winding as in claim 2, further comprising:
an encapsulating layer being applied to said secondary winding.

7. A secondary winding for use in an ignition coil, comprising:
a spool having a winding surface;
a first layer of tape being applied to said winding surface, said first layer of tape having an adhesive material on both sides;
a first winding layer being wound onto said first layer of tape, said first winding layer being encapsulated in said adhesive material; and
a plurality of successive layers being wound on top of said first winding layer, each of said plurality of successive layers comprising two layers of tape having an adhesive material on both sides and a winding positioned between each layer of tape, said secondary winding being heat cured after said plurality of successive layers are wound onto said spool.

8. The secondary winding as in claim 7, wherein said tape is a heat shrinkable material.

9. The secondary winding as in claim 8, wherein said heat shrinkable material is polyester having a thickness from about 0.001 inches to 0.002 inches.

10. The secondary winding as in claim 10, wherein said adhesive is applied with a thickness from about 0.0005 inches to 0.002 inches.

11. The secondary winding as in claim 10, wherein said adhesive is selected from the group consisting of acrylic or silicone.

12. The secondary winding as in claim 7, wherein said first layer is electrically terminated to a core on an ignition coil.

13. The secondary winding as in claim 7, wherein said tape is a non-heat shrinkable material and a heat shrinkable tube is placed over the entire assembly.

14. The secondary winding as in claim 13, further comprising:
an encapsulating layer being applied to said heat shrinkable tube.

15. An ignition coil for an internal combustion engine, comprising:
a primary winding adapted to be electrically connected to a low-voltage ignition signal;
a secondary winding inductively coupled to said primary winding with more turns than said primary winding so that said secondary winding develops a high-voltage ignition signal in response to switching of said low-voltage ignition signal, said turns of said secondary winding are provided in successive layers and a film is located between each of said successive layers, said film having an adhesive on both sides for encapsulating said turns of said secondary winding.

16. The ignition coil as in claim 15, wherein said film is a heat shrinkable material.

17. An ignition coil for an internal combustion engine, said ignition coil comprising:
a primary winding adapted to be electrically connected to a low-voltage ignition signal; and
a secondary winding inductively coupled to the primary winding with more turns than said primary winding so that said secondary winding develops a high-voltage ignition signal in response to switching of said low-voltage ignition signal, said secondary winding having a spool with a winding surface an uncured stage material is applied to said winding surface in an amount to cover at least a first layer of turns of said secondary winding.

18. A method of manufacturing an ignition coil, comprising:
applying an uncured stage material to a surface of a spool;
wrapping a first layer of secondary winding material about said spool;
repeating said steps of wrapping and surrounding to define successive layers of a secondary winding; and
applying a primary winding around the secondary winding.

19. The method as in claim 18, wherein said step of wrapping is performed around a spool that surrounds a magnetic core.

20. The method as in claim 19, further comprising:
surrounding said primary winding with a pencil coil housing having a cavity adapted to receive a central terminal of a spark plug and make electrical contact between the central terminal and a high-voltage end of said secondary winding.

21. A method of manufacturing a secondary winding of an ignition coil, comprising:
applying a first layer of tape to a winding surface of a spool, said tape having an adhesive on both sides;
wrapping a first layer of secondary winding material about said first layer of tape; and
wrapping a plurality of successive layers about said first layer, each of said successive layers having two layers of tape having adhesive on both sides and a layer of winding material disposed between said two layers of tape.

22. The method as in claim 21, further comprising:
heating the secondary coil.
